(19) United States
(12) Patent Application Publication
(10) Pub. No.: US 2021/0087870 A1
(43) Pub. Date: Mar. 25, 2021

(54) MAGNETIC ATTRACTION THRESHOLD

(71) Applicant: Hsing-Hua KUAN, Taipei (TW)

(72) Inventor: Hsing-Hua KUAN, Taipei (TW)

(21) Appl. No.: 16/579,813

(22) Filed: Sep. 23, 2019

(51) Int. Cl. E06B 1/70

(52) U.S. Cl. CPC E06B 1/70; E06B 2001/707

(57) ABSTRACT

A magnetic attraction threshold contains: an accommodation holder, a stopper, and at least one magnetic element. The base includes an open segment, a first groove, and a second groove. The first groove includes a first opening, the second groove includes a second opening, and the first groove and the second groove are symmetrically formed inside the hollow accommodation holder. The stopper includes a stop sheet, a first fixing fence, and a second fixing fence. The first fixing fence and the second fixing fence extend from a bottom of the stop sheet respectively. The stop sheet includes a trench configured to accommodate the at least one magnetic element. The stopper is connected in the accommodation holder. The first fixing fence is movably inserted into the first groove via the first opening, and the second fixing fence is movably inserted into the second groove via the second opening.

### FIELD OF THE INVENTION

The present invention relates to a device for shielding a door seam, and more particularly to a magnetic attraction threshold which shields or opens the door seam by ways of a door leaf.

### DESCRIPTION OF THE PRIOR ART

A conventional door leaf rotates relative to a door frame. To rotate the door leaf smoothly, a size of the door frame is more than that of the door leaf, so a door seam exists between the door leaf and a ground, and sounds, smokes, dusts, bugs or waters enter into a room via the door.

To overcome above-mentioned problem, an electric lift threshold is disclosed in U.S. D738,532 S and contains a hollow accommodation holder and at least one electric moving device accommodated in the accommodation holder. The electric moving device includes a drive rod and a stopper having a stop sheet and at least one fixing fence. The at least one fixing fence extends from a bottom of the stop sheet, and the at least one fixing fence has a first fringe and a second fringe symmetrical to the first fringe. The accommodation holder further includes a first groove and a second groove, wherein the first groove has a first opening defined on a top thereof, the second groove has a second opening defined on a top thereof, wherein the first groove and the second groove are symmetrically formed on the accommodation holder. The first fringe is inserted into the first groove via the first opening, and the second fringe is inserted into the second groove via the second opening. Thereby, the electric moving device is opened to actuate the drive rod to push the stopper toward the open segment of the accommodation holder at a distance and suspends. After opening the electric moving device once more, the drive rod is actuated to drive the stopper to move back to an original position.

However, the electric lift threshold is driven to extend out of or retract into a closing device to close the door seam by using a complicated structure. The electric lift threshold is not environmentally friendly by ways of a power. Furthermore, when the door has multiple door leaves, a slit exists between any two adjacent door leaves, and it is not suitable to fix the drive rod between the door leaves. When multiple electric lift threshold ate fixed on multiple door leaves respectively, the multiple closing device close the door seams from bottoms of the multiple door leaves individually after closing the multiple door leaves, the multiple closing devices drop from the multiple door leaves to close the multiple door seams respectively, but slits exist among the multiple closing devices, the sounds, bugs, smokes, and waters enter into the room easily.

The present invention has arisen to mitigate and/or obviate the afore-described disadvantages.

### SUMMARY OF THE INVENTION

The primary aspect of the present invention is to provide a magnetic attraction threshold which is mounted on any desired position of a door so as to shield a door seam and to overcome above-mentioned defects.

To obtain the above aspects, a magnetic attraction threshold provided by the present invention contains: an accommodation holder, a stopper, and at least one magnetic element.

The base includes an open segment, a first groove, and a second groove. The first groove includes a first opening defined on a top thereof, the second groove includes a second opening formed on a top thereof, and the first groove and the second groove are symmetrically formed inside the hollow accommodation holder.

The stopper includes a stop sheet, a first fixing fence, and a second fixing fence. The first fixing fence and the second fixing fence extend from a bottom of the stop sheet respectively, and the stop sheet includes a trench formed on the bottom thereof and configured to accommodate the at least one magnetic element.

The stopper is connected in the accommodation holder so that the first fixing fence and the second fixing fence are movably received in the accommodation holder, and the stop sheet is adjacent to the open segment.

The first fixing fence is movably inserted into the first groove via the first opening, and the second fixing fence is movably inserted into the second groove via the second opening.

Thereby, the at least one magnetic element is magnetically attracted by at least one magnetic attraction metal or at least one hetero magnetic element so as to actuate the stopper to extend out of the open segment of the accommodation holder. Hence, the stopper shields or closes a door leaf or insulates sounds of the door leaf.

The magnetic attraction threshold is connected on the door which includes a door frame and the door leaf. The door leaf is movably connected inside the door frame. The magnetic attraction threshold is connected with the door frame and the door leaf A width of the magnetic attraction threshold matches with that of the door leaf, and an interior of a bottom of the door leaf is connected with the at least one magnetic attraction metal (or the hetero magnetic element) so that the door leaf is closed to the door frame. The at least one magnetic attraction metal (or the hetero magnetic element) corresponds to a top of the at least one magnetic element. The at least one magnetic element is magnetically attracted by the at least one magnetic attraction metal (or the at least one hetero magnetic element) to actuate the stopper to abut against a bottom of the door leaf upward, the stop sheet closes the bottom of the door leaf, and the first fixing fence and the second fixing fence shield a gap between the door leaf and a floor. Thereby, the magnetic attraction threshold shields and closes the gap or insulates the sounds. When the door leaf is opened to be away from the door frame, the at least one magnetic attraction metal (or the hetero magnetic element) moves away from the at least one magnetic element, and the stopper drops and is accommodated in the accommodation holder.

In another embodiment, a magnetic attraction threshold contains: an accommodation holder, a stopper, and at least one magnetic attraction metal.

The base includes an open segment, a first groove, and a second groove. The first groove includes a first opening defined on a top thereof, the second groove includes a second opening formed on a top thereof, and the first groove and the second groove are symmetrically formed inside the hollow accommodation holder.

The stopper includes a stop sheet, a first fixing fence, and a second fixing fence. The first fixing fence and the second fixing fence extend from a bottom of the stop sheet respectively, and the stop sheet includes a trench formed on the bottom thereof and configured to accommodate the at least one magnetic attraction metal.

The stopper is connected in the accommodation holder so that the first fixing fence and the second fixing fence are movably received in the accommodation holder, and the stop sheet is adjacent to the open segment.

The first fixing fence is movably inserted into the first groove via the first opening, and the second fixing fence is movably inserted into the second groove via the second opening.

Preferably, the magnetic attraction threshold is connected on a door which includes a door frame and the door leaf, wherein the door leaf is movably connected inside the door frame, the magnetic attraction threshold is connected with the door frame and the door leaf, and an interior of a bottom of the door leaf is connected with at least one magnetic element.

The accommodation holder and the stopper of the magnetic attraction threshold are fixed in the ground trough below the door so as to actuate the stopper to extend out of the door seam in a magnetic attraction effect. Preferably, the magnetic attraction threshold is fixed in the ground trough to match with the door with multiple door leaves so as to completely close the door seam among bottoms of the multiple door leaves and the ground, thus insulating the sounds and stopping smokes, insects, waters, and dusts.

When opening the door, the stopper is accommodated in the accommodation holder by opening and closing the door leaf Preferably, the magnetic attraction threshold is fixed on a slit of an upper portion of the door frame and the door leaf. Alternatively, the magnetic attraction threshold is fixed on at least two door leaves so as to shield a slit of the at least two door leaves.

### BRIEF DESCRIPTION OF THE DRAWINGS

FIG. 1 is a side plan view showing the assembly of a magnetic attraction threshold according to a preferred embodiment of the present invention.

FIG. 2 is a side plan view showing the exploded components of the magnetic attraction threshold according to the preferred embodiment of the present invention.

FIG. 3 is a perspective view showing the operation of the magnetic attraction threshold according to the preferred embodiment of the present invention.

FIG. 4 is another perspective view showing the operation of the magnetic attraction threshold according to the preferred embodiment of the present invention.

FIG. 5 is also another perspective view showing the operation of the magnetic attraction threshold according to the preferred embodiment of the present invention.

FIG. 6 is still another perspective view showing the operation of the magnetic attraction threshold according to the preferred embodiment of the present invention.

FIG. 7 is a perspective view showing the operation of a magnetic attraction threshold according to another preferred embodiment of the present invention.

FIG. 8 is another perspective view showing the operation of the magnetic attraction threshold according to another preferred embodiment of the present invention.

### DETAILED DESCRIPTION OF THE PREFERRED EMBODIMENTS

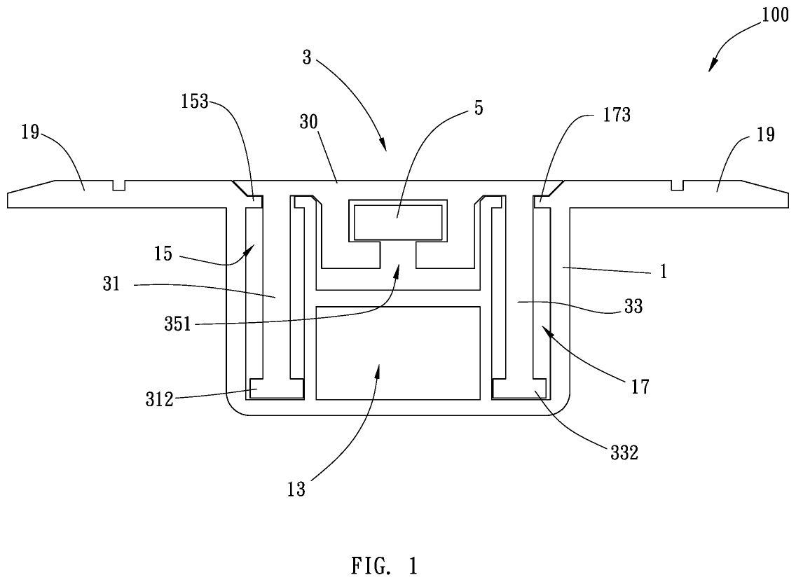

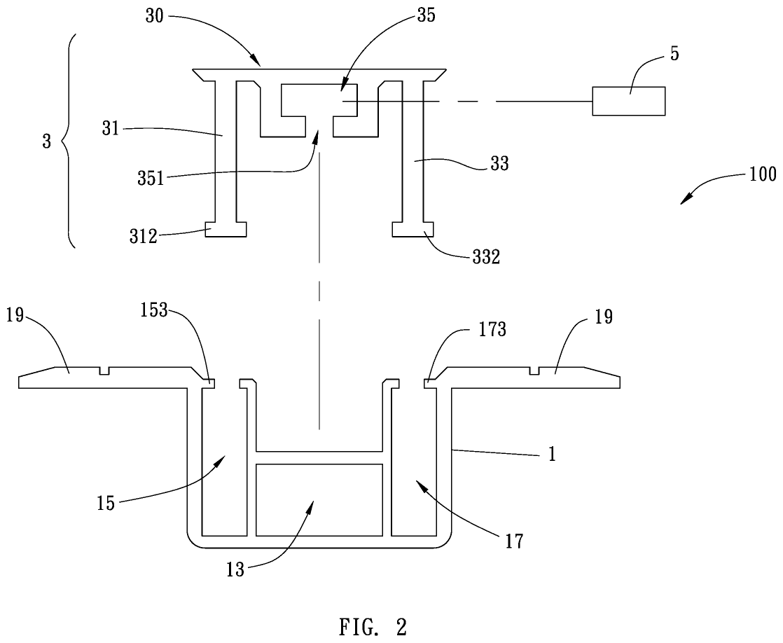

With reference to FIGS. 1-3, a magnetic attraction threshold 100 according to a preferred embodiment of the present invention comprises: a hollow accommodation holder 1, a stopper 3, at least one magnetic element 5.

The base 1 includes an open segment 11, a first groove 15, and a second groove 17, wherein the first groove 15 includes a first opening 151 defined on a top thereof, the second groove 17 includes a second opening 171 formed on a top thereof, and the first groove 15 and the second groove 17 are symmetrically formed inside the hollow accommodation holder 1.

The stopper 3 includes a stop sheet 30, a first fixing fence 31, and a second fixing fence 33, wherein the first fixing fence 31 and the second fixing fence 33 extend from a bottom of the stop sheet 30 respectively, and the stop sheet 30 includes a trench 35 formed on the bottom thereof and configured to accommodate the at least one magnetic element 5.

The stopper 3 is connected in the accommodation holder 1 so that the first fixing fence 31 and the second fixing fence 33 are movably received in the accommodation holder 1, and the stop sheet 30 is adjacent to the open segment 11.

The first fixing fence 31 is movably inserted into the first groove 15 via the first opening 151, and the second fixing fence 33 is movably inserted into the second groove 17 via the second opening 171, such that the at least one magnetic element 5 is magnetically attracted by at least one magnetic attraction metal or at least one hetero magnetic element so as to actuate the stopper 3 to extend out of the open segment 11 of the accommodation holder 1. Hence, the stopper 3 shields or closes a door leaf or insulates sounds of the door leaf Preferably, the at least one magnetic attraction metal or the hetero magnetic element magnetically attracts a top of the at least one magnetic element 5.

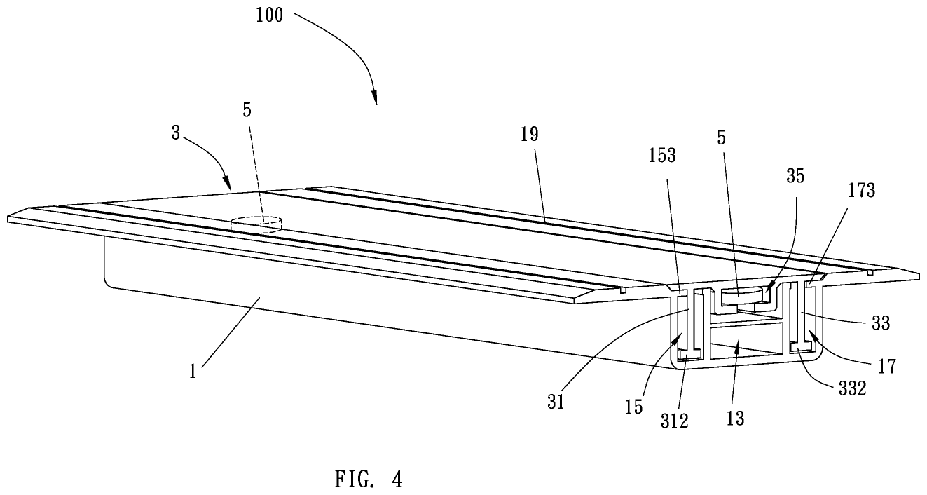

Referring to FIGS. 1-7, the magnetic attraction threshold 100 is connected on the door 7 which includes a door frame 71 and the door leaf 73, wherein the door leaf 73 is movably connected inside the door frame 71. The magnetic attraction threshold 100 is connected with the door frame 71 and the door leaf 73, wherein a width of the magnetic attraction threshold 100 matches with that of the door leaf 73, and an interior of a bottom of the door leaf 73 is connected with the at least one magnetic attraction metal (or the hetero magnetic element) 75 so that the door leaf 73 is closed to the door frame 71. The at least one magnetic attraction metal (or the hetero magnetic element) 75 corresponds to a top of the at least one magnetic element 5, wherein the at least one magnetic element 5 is magnetically attracted by the at least one magnetic attraction metal (or the at least one hetero magnetic element) 75 to actuate the stopper 3 to abut against a bottom of the door leaf 73 upward, the stop sheet 30 closes the bottom of the door leaf 73, and the first fixing fence 31 and the second fixing fence 33 shield a gap between the door leaf 73 and a floor. Thereby, the magnetic attraction threshold 100 shields and closes the gap or insulates the sounds. When the door leaf 73 is opened to be away from the door frame 71, the at least one magnetic attraction metal (or the hetero magnetic element) 75 moves away from the at least one magnetic element 5, and the stopper 3 drops and is accommodated in the accommodation holder 1. The magnetic material 5 is any one of a magnet, a neodymium magnet, a magnetite and an alloy magnet. The at least one magnetic attraction metal 75 is made of any one of iron, copper, steel, alloy, tin, and other magnetic material.

Accordingly, the magnetic attraction threshold 100 facilitates opening and closing the door. When closing the door, the stopper 3 is magnetically attracted to shield the gap. When opening the door, the stopper moves back to the accommodation holder 1, thus moving the door leaf easily.

As shown in FIGS. 1-7, the at least one magnetic element 5 is an elongated magnetic element accommodated in the trench 35, and a number, a volume, a size, and a position of the at least one magnetic attraction metal (or the at least one hetero magnetic element) 75 corresponds to the at least one magnetic element 5 so that the stop sheet 30 and the magnetic element 5 are magnetically attracted by the at least one magnetic attraction metal (or the at least one hetero magnetic element) 75.

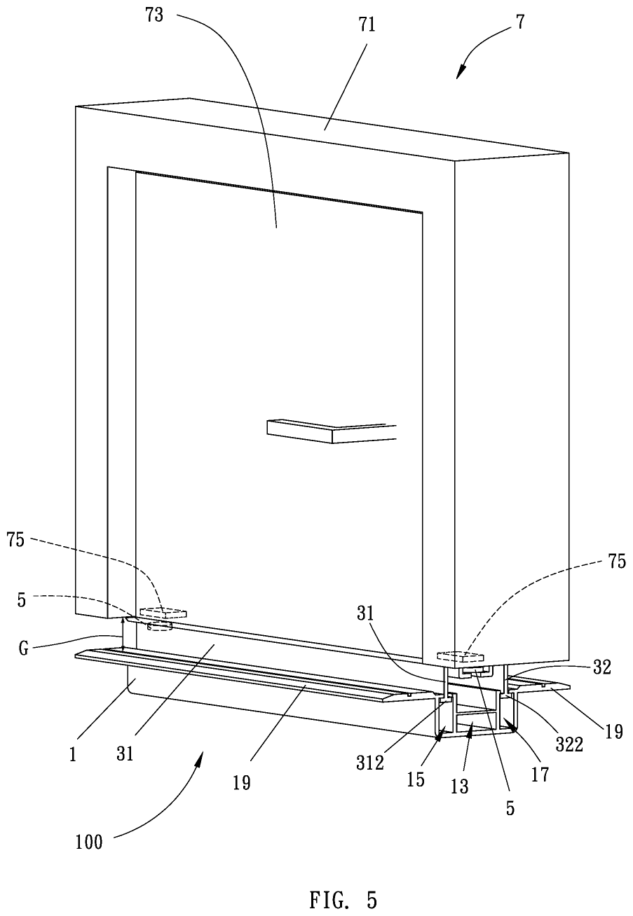

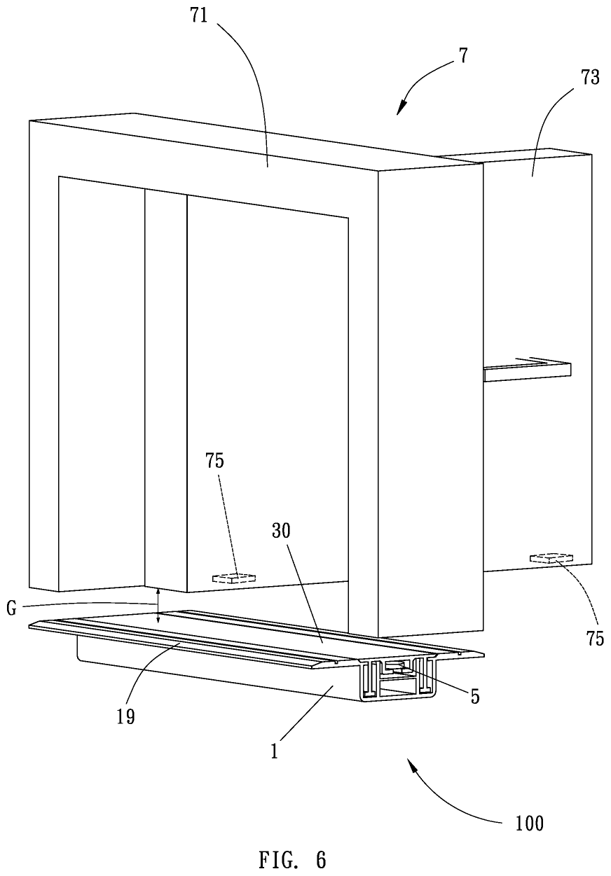

As illustrated in FIGS. 5 and 6, in another embodiment, multiple magnetic elements 5 are separately mounted in the trench 35, and multiple magnetic attraction metals (or the hetero magnetic elements) 75 are provided to correspond to the multiple magnetic elements 5 respectively. For example, two magnetic elements 5 are symmetrically mounted on two sides of the trench 35 of the stop sheet 30. Alternatively, three magnetic elements 5 are symmetrically mounted on two sides of the trench 35 of the stop sheet 30, wherein two of the three magnetic elements 5 are symmetrically mounted on two sides of the trench 35 of the stop sheet 30, and the other magnetic element 5 is fixed on a middle position of the trench 35, three magnetic attraction metals (or three hetero magnetic elements) 75 are fixed in an interior of a bottom of the door leaf 73 to correspond to the multiple magnetic elements 5 respectively. A number, a volume, a size or a position of the multiple magnetic elements 5 corresponds to that of the multiple magnetic attraction metals (or the multiple hetero magnetic elements) 75, for example, the three magnetic attraction metals (or the three hetero magnetic elements) 75 are provided, such that the stop sheet 30 and the three magnetic elements 5 are magnetically attracted by the three magnetic attraction metals (or the three hetero magnetic elements) 75 upward so as to abut against the door leaf 73.

With reference to FIGS. 1-4, the first opening 151 has two first flanges 153 symmetrically formed on an edge thereof, the second opening 171 has two second flanges 173 symmetrically formed on an edge thereof. The first fixing fence 31 has a first T-shaped shoulder 312 formed on a free end thereof, and the second fixing fence 33 has a second T-shaped shoulder 332 formed on a free end thereof. Thereby, the at least one magnetic element 5 of the stopper 3 is magnetically attracted by the at least one magnetic attraction metal (or the at least one hetero magnetic element) 75 upward, the first T-shaped shoulder 312 of the first fixing fence 31 abuts against the two first flanges 153 so as to close the first opening 151, and the second T-shaped shoulder 332 of the second fixing fence 33 abuts against the two first flanges 173 so as to close the second opening 171 to avoid the stopper 3 removing from the accommodation holder 1, and the first fixing fence 31 moves in the first groove 15, the second fixing fence 33 moves in the second groove 17.

Referring to FIGS. 1-4, the trench 35 has a slit 351 extending from a bottom thereof, and the slit 351 has a slot structure extending from the bottom of the trench 35. When the at least one magnetic element 5 is accommodated in the trench 35, the slit 351 produces a working margin so that the at least one magnetic element 5 is accommodated in the trench 35 smoothly.

As shown in FIGS. 1-7, the accommodation holder 1 includes two pedals 19 extending from the two sides of the open segment 11 of the accommodation holder 1 respectively, the two pedals 19 are configured to contact and flush with the stop sheet 30 adjacent to the open segment 11 of the accommodation holder 1 so as to avoid a user's feet touching the stop sheet 30. Alternatively, a wheelchair moves across the stop sheet 30 by ways of the two pedals 19. The construction unit is capable of fixing the magnetic attraction threshold 100 on two sides of a ground trough, the door frame or a peripheral side of the door leaf.

When closing the door leaf 73, the at least one magnetic attraction metal (or the at least one hetero magnetic element) 75 magnetically attracts and actuates the at least one magnetic element 5 and the stopper 30 to move toward the opening segment 11 of the accommodation holder 1 at a distance, and then the at least one magnetic element 5 and the stopper 30 stop so as to shield a door seam below the door leaf 73, and after the door leaf 70 is opened, the stopper 3 is actuated to move back to the accommodation holder 1.

The stopper 3 is made of any one of non-magnetic metal, composite material, rubber, silicone, and plastic, wherein the non-magnetic metal is any one of aluminum, aluminum alloy and other non-magnetic metal materials.

As shown in FIGS. 1-4, a size of each of the first groove 15 and the second groove 17 is more than a volume of each of the first fixing fence 31 and the second fixing fence 33, such that the first fixing fence 31 has a sufficient margin to move in the first groove 15, and the second fixing fence 33 has a sufficient margin to move in the second groove 17. When the first fixing fence 31 and the second fixing fence 33 move, they do not resist against the magnetic attraction threshold 100 so that when the stopper 3 and the first fixing fence 31 deform in an ambient temperature or in a quick movement, they are magnetically attracted out of the accommodation holder 1 or are released to move back to the accommodation holder 1.

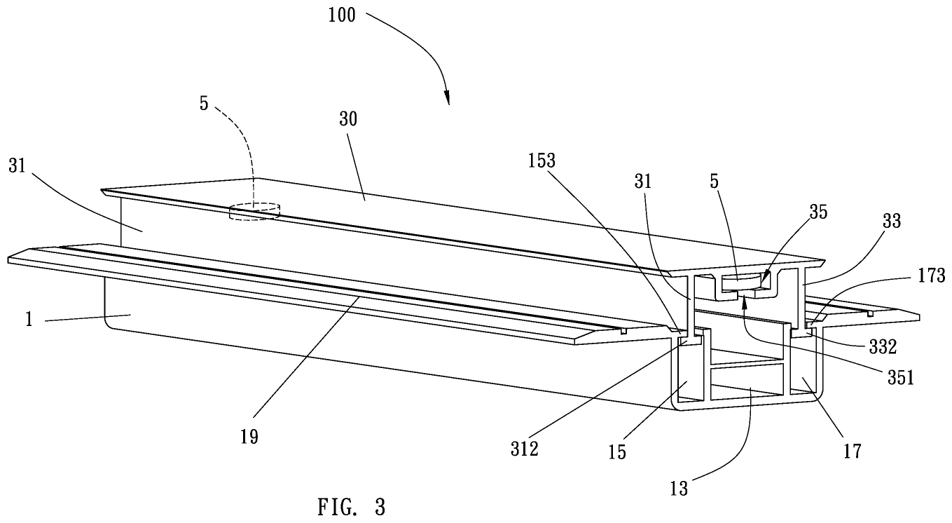

With reference to FIGS. 3-8, the accommodation holder 1 and the stopper 3 of the magnetic attraction threshold 100 are elongated and are fixed in the ground trough below the door so as to actuate the stopper 3 to extend out of the door seam G in a magnetic attraction effect. Preferably, the magnetic attraction threshold 100 is fixed in the ground trough to match with the door with multiple door leaves so as to completely close the door seam G among bottoms of the multiple door leaves and the ground, thus insulating the sounds and stopping smokes, insects, waters, and dusts.

The magnetic attraction threshold 100 is fixed on a slit of an upper portion of the door frame and the door leaf. Alternatively, the magnetic attraction threshold 100 is fixed on at least two door leaves so as to shield a slit of the at least two door leaves.

Referring to FIGS. 1 and 4-7, the accommodation holder 1 further includes a box structure 13 formed from the bottom of the accommodation holder 1, and two sides of the box structure 13 are connected with the first groove 15 and the second groove 17 respectively. A rigidity of the accommodation holder 1 is enhanced by ways of the box structure 1. For example, the magnetic attraction threshold 100 is fixed on the door seam, the accommodation holder 1 has a predetermined length to avoid the magnetic attraction threshold 100 being deformed by the door leaf 73. Preferably, the rigidity of the box structure 13 is enhanced to avoid a deformation of the magnetic attraction threshold 100.

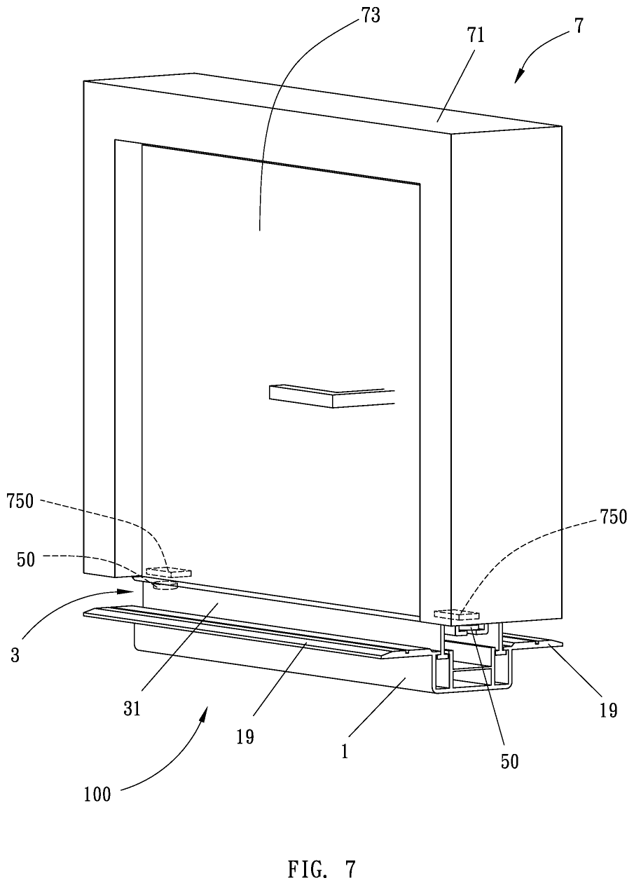

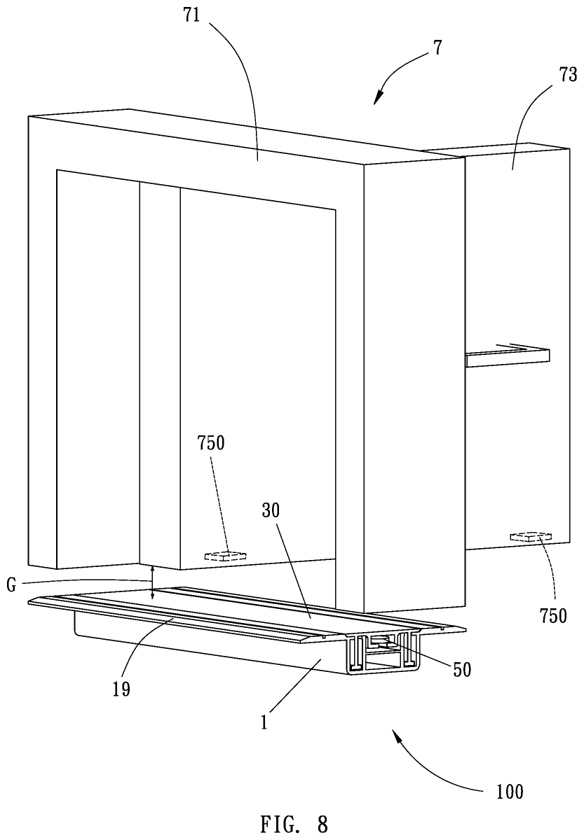

Referring to FIGS. 7 and 8, in another embodiment, the magnetic attraction threshold 100 includes an accommodation holder 1, a stopper 3, and at least one magnetic attraction metal 50.

The accommodation holder 1 includes an open segment 11, a first groove 15, and a second groove 17, wherein the first groove 15 includes a first opening 151 defined on a top thereof, the second groove 17 includes a second opening 171 formed on a top thereof, and the first groove 15 and the second groove 17 are symmetrically formed inside the hollow accommodation holder 1.

The stopper 3 includes a stop sheet 30, a first fixing fence 31, and a second fixing fence 33, wherein the first fixing fence 31 and the second fixing fence 33 extend from a bottom of the stop sheet 30 respectively, and the stop sheet 30 includes a trench 35 formed on the bottom thereof and configured to accommodate the at least one magnetic attraction metal 50.

The stopper 3 is connected in the accommodation holder 1 so that the first fixing fence 31 and the second fixing fence 33 are movably received in the accommodation holder 1, and the stop sheet 30 is adjacent to the open segment 11.

The first fixing fence 31 is movably inserted into the first groove 15 via the first opening 151, and the second fixing fence 33 is movably inserted into the second groove 17 via the second opening 171, such that the at least one magnetic attraction metal 50 is magnetically attracts by an external magnetic attraction metal or a hetero magnetic element so as to actuate the stopper 3 to extend out of the open segment 11 of the accommodation holder 1. Hence, the stopper 3 shields or closes a door leaf or insulates sounds of the door leaf Preferably, the external magnetic attraction metal or the hetero magnetic element magnetically attracts a top of the at least one magnetic attraction metal 50.

As shown in FIGS. 7 and 8, the magnetic attraction threshold 100 is connected on a door 7 which includes a door frame 71 and the door leaf 73, wherein the door leaf 73 is movably connected inside the door frame 71. The magnetic attraction threshold 100 is connected with the door frame 71 and the door leaf 73, wherein a width of the magnetic attraction threshold 100 matches with that of the door leaf 73, and an interior of a bottom of the door leaf 73 is connected with at least one magnetic element 750 so that the door leaf 73 is closed to the door frame 71. The at least one magnetic element 750 corresponds a top of the at least one magnetic attraction metal 50, wherein the at least one magnetic attraction metal 50 is magnetically attracted by the at least one magnetic element 750 to actuate the stopper 3 to abut against a bottom of the door leaf 73 upward, the stop sheet 30 closes the bottom of the door leaf 73, and the first fixing fence 31 and the second fixing fence 33 shield a gap between the door leaf 73 and a floor. Thereby, the magnetic attraction threshold 100 shields and closes the gap or insulates the sounds. When the door leaf 73 is opened to be away from the door frame 71, the at least one magnetic element 750 moves away from the at least one magnetic attraction metal 50, and the stopper 3 drops and is accommodated in the accommodation holder 1.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A magnetic attraction threshold comprising: an accommodation holder, a stopper, and at least one magnetic element;
the base including an open segment, a first groove, and a second groove, wherein the first groove includes a first opening defined on a top thereof, the second groove includes a second opening formed on a top thereof, and the first groove and the second groove are symmetrically formed inside the hollow accommodation holder;
the stopper including a stop sheet, a first fixing fence, and a second fixing fence, wherein the first fixing fence and the second fixing fence extend from a bottom of the stop sheet respectively, and the stop sheet includes a trench formed on the bottom thereof and configured to accommodate the at least one magnetic element;
the stopper being connected in the accommodation holder so that the first fixing fence and the second fixing fence are movably received in the accommodation holder, and the stop sheet is adjacent to the open segment;
wherein the first fixing fence is movably inserted into the first groove via the first opening, and the second fixing fence is movably inserted into the second groove via the second opening.

2. The magnetic attraction threshold as claimed in claim 1, wherein the magnetic attraction threshold is connected on a door which includes a door frame and the door leaf, wherein the door leaf is movably connected inside the door frame, the magnetic attraction threshold is connected with the door frame and the door leaf, and an interior of a bottom of the door leaf is connected with at least one magnetic attraction metal or at least one hetero magnetic element.

3. The magnetic attraction threshold as claimed in claim 1, wherein the at least one magnetic element matches with the stop sheet and is a sole magnetic element accommodated in the trench, the at least one magnetic attraction metal is a sole magnetic attraction metal or the at least one hetero magnetic element is a sole hetero magnetic element so as to correspond to the sole magnetic element.

4. The magnetic attraction threshold as claimed in claim 1, wherein the at least one magnetic element is multiple magnetic elements, the multiple magnetic elements are separately mounted in the trench, and multiple magnetic attraction metals or multiple hetero magnetic elements are provided to correspond to the multiple magnetic elements respectively.

5. The magnetic attraction threshold as claimed in claim 1, wherein the first opening has two first flanges symmetrically formed on an edge thereof, the second opening has two second flanges symmetrically formed on an edge thereof; the first fixing fence has a first T-shaped shoulder formed on a free end thereof, and the second fixing fence has a second T-sped shoulder formed on a free end thereof.

6. The magnetic attraction threshold as claimed in claim 1, wherein the trench has a slit extending from a bottom thereof, and the slit has a slot structure extending from the bottom of the trench.

7. The magnetic attraction threshold as claimed in claim 1, wherein the stopper is made of any one of non-magnetic metal, composite material, rubber, silicone, and plastic.

8. The magnetic attraction threshold as claimed in claim 1, wherein the accommodation holder further includes a box structure formed from the bottom of the accommodation holder, and two sides of the box structure are connected with the first groove and the second groove respectively.

9. The magnetic attraction threshold as claimed in claim 4, wherein the accommodation holder further includes a box structure formed from the bottom of the accommodation holder, and two sides of the box structure are connected with the first groove and the second groove respectively.

10. The magnetic attraction threshold as claimed in claim 6, wherein the accommodation holder further includes a box structure formed from the bottom of the accommodation holder, and two sides of the box structure are connected with the first groove and the second groove respectively.

11. A magnetic attraction threshold comprising: an accommodation holder, a stopper, and at least one magnetic attraction metal;
the base including an open segment, a first groove, and a second groove, wherein the first groove includes a first opening defined on a top thereof, the second groove includes a second opening formed on a top thereof, and the first groove and the second groove are symmetrically formed inside the hollow accommodation holder;
the stopper including a stop sheet, a first fixing fence, and a second fixing fence, wherein the first fixing fence and the second fixing fence extend from a bottom of the stop sheet respectively, and the stop sheet includes a trench formed on the bottom thereof and configured to accommodate the at least one magnetic attraction metal;
the stopper being connected in the accommodation holder so that the first fixing fence and the second fixing fence are movably received in the accommodation holder, and the stop sheet is adjacent to the open segment;
wherein the first fixing fence is movably inserted into the first groove via the first opening, and the second fixing fence is movably inserted into the second groove via the second opening.

12. The magnetic attraction threshold as claimed in claim 11, wherein the magnetic attraction threshold is connected on a door which includes a door frame and the door leaf, wherein the door leaf is movably connected inside the door frame, the magnetic attraction threshold is connected with the door frame and the door leaf, and an interior of a bottom of the door leaf is connected with at least one magnetic element.
